(19) United States
(12) Patent Application Publication
(10) Pub. No.: US 2021/0243046 A1
(43) Pub. Date: Aug. 5, 2021

(54) VEHICLE RELAY DEVICE

(71) Applicant: DENSO CORPORATION, Kariya-city (JP)

(72) Inventor: Akira TADA, Kariya-city (JP)

(21) Appl. No.: 17/234,840

(22) Filed: Apr. 20, 2021

Related U.S. Application Data
(63) Continuation of application No. PCT/JP2019/039514, filed on Oct. 7, 2019.

(30) Foreign Application Priority Data
Oct. 29, 2018 (JP) 2018-202873

(51) Int. Cl. H04L 12/40

(52) U.S. Cl. CPC H04L 12/40013; H04L 2012/40273

(57) ABSTRACT

A vehicle relay device includes a plurality of physical (PHY) modules and a PHY manager. The plurality of PHY modules are configured to communicate in accordance with an Ethernet standard. The PHY manager is connected to the plurality of PHY modules. The PHY manager changes an operation setting of each of the plurality of PHY modules and monitors an operation state of each of the plurality of PHY modules.

### CROSS REFERENCE TO RELATED APPLICATIONS

The present application is a continuation application of International Patent Application No. PCT/JP2019/039514 filed on Oct. 7, 2019, which designated the U.S. and claims the benefit of priority from Japanese Patent Application No. 2018-202873 filed on Oct. 29, 2018. The entire disclosures of all of the above applications are incorporated herein by reference.

### TECHNICAL FIELD

The present disclosure relates to a vehicle relay device that is a relay device constituting a communication network in a vehicle.

### BACKGROUND

Ethernet communication networks have been widely used in offices and homes. Ethernet is registered trademark. Further, in recent years, introduction of Ethernet has been progressing in vehicles from the viewpoint of improving communication speed and the like.

### SUMMARY

The present disclosure provides a vehicle relay device. The vehicle relay device includes a plurality of physical (PHY) modules and a PHY manager. The plurality of PHY modules are configured to communicate in accordance with an Ethernet standard. The PHY manager is connected to the plurality of PHY modules. The PHY manager changes an operation setting of each of the plurality of PHY modules and monitors an operation state of each of the plurality of PHY modules.

### BRIEF DESCRIPTION OF DRAWINGS

The features and advantages of the present disclosure will become more apparent from the following detailed description made with reference to the accompanying drawings. In the drawings:

FIG. 1 is a diagram showing an example of a vehicle communication system using a relay device;

FIG. 2 is a diagram schematically showing an example of a configuration of the relay device;

FIG. 3 is a diagram schematically showing a configuration of a PHY manager;

FIG. 4 is a diagram showing a connection configuration between an input /output circuit and a PHY;

FIG. 5 is a diagram showing a first comparative configuration;

FIG. 6 is a diagram showing an operation of the first comparative configuration;

FIG. 7 is a diagram showing a second comparative configuration;

FIG. 8 is a diagram showing an operation of the second comparative configuration;

FIG. 9 is a diagram showing an operation of an embodiment;

FIG. 10 is a diagram showing a first modification; and

FIG. 11 is a diagram showing a second modification.

### DETAILED DESCRIPTION

For example, a device (hereinafter referred to as a relay device) that provides a relay function for a communication frame in a communication network in accordance with an Ethernet standard includes a plurality of PHY modules and a plurality of MAC units. The PHY module provides a physical layer and is packaged as a PHY chip with, for example, one or two ports. The MAC unit executes medium access control, and is provided for each of the plurality of PHY modules. As an interface between the PHY module and the MAC unit related to transmission and reception of the communication frame, various methods such as Media Independent Interface (MII) and Reduced MII (RMII) can be applied.

Further, the relay device includes a PHY manager that controls an operation of the PHY module. The PHY manager is connected to the PHY module via a signal line (hereinafter, MDIO line) for inputting and outputting management data, which is data for managing the PHY module. The PHY manager rewrites a value of a register of the PHY module in order to change an operation setting of the PHY module and reads out the register value of the PHY module via the MDIO line. MDIO is an abbreviation for Management Data Input/Output. Transmission and reception of the management data via the MDIO line is performed with reference to a clock edge of a Management Data Clock (MDC), which is a dedicated clock signal output by the PHY manager. The PHY manager is controlled by a higher-level entity (hereinafter, a higher-level layer). The upper layers are often provided by a computer. Further, the function as the PHY manager is often built in a dedicated IC that provides a function as a MAC unit.

As a first exemplary configuration of the relay device (hereinafter, a first assumption configuration), it is considered that an MDIO line and an MDC connected to each PHY module are shared, and a plurality of PHYs are sequentially controlled (for example, time division) using one PHY manager. According to the first assumption configuration described above, since the relay device includes one PHY manager, it is relatively easy for the upper layer to manage and control the PHY manager. However, since the first assumption configuration shares the MDIO line by the plurality of PHY modules, the PHY manager needs to transmit and receive data while designating the PHY module as a communication target. Further, one PHY module can communicate at a time. Thus, when it is necessary to communicate with a plurality of PHY modules, the first assumption configuration accesses the plurality of PHY modules in order. In other words, the first assumption configuration cannot access the plurality of PHY modules at the same time. Therefore, there is a difficulty that communication speed between the PHY module and the PHY manager is slow.

In a vehicle, while a power source for traveling (for example, an ignition power source) is off (that is, while parking), power supply to various ECUs is cut off in order to suppress dark current. From the viewpoint of suppressing the dark current, it is preferable to turn off the power supply to the vehicle relay device. In a configuration in which the power supply to the vehicle relay device is turned off during parking, the vehicle relay device performs a predetermined activation process (so-called boot process) by an occurrence of a predetermined event as a trigger, such as when the power for the vehicle is turned on.

The relay device including the vehicle relay device performs a process, as the boot process, for writing data indicating an operation setting of the PHY module via the MDIO line. The operation setting of the PHY module refers to, for example, an Ethernet communication standard or a serial transmission method applied to the PHY module. The vehicle relay device cannot communicate with the ECU or the like unless the writing of the operation setting to the register provided in each PHY module by the PHY manager is completed. The ECUs cannot communicate with each other unless the vehicle relay device can communicate with the ECUs. Further, in order for the vehicle to start traveling, it is necessary that the ECUs can normally communicate with each other. When it takes long time to activate the vehicle relay device, the user may have to wait after the power for traveling is turned on. Therefore, there is a demand for shortening the start-up time of the vehicle relay device as much as possible.

As a second exemplary configuration of the relay device (hereinafter, a second assumption configuration), a plurality of PHY managers corresponding to a plurality of respective PHY modules control the plurality of respective PHY modules in parallel and independently. The second assumption configuration can write data to the plurality of PHY modules at the same time. Thus, it is expected that the startup time and the like can be shortened and the communication speed between the PHY module and the PHY manager can be improved. However, the second assumption configuration includes a plurality of PHY managers. Thus, there is a difficulty that control of the PHY manager by the upper layer is complicated.

The calculation load for controlling a plurality of PHY managers is unlikely to be a difficulty when a relatively high-performance processor is employed. However, in the vehicle relay device, from the viewpoint of environmental resistance, such as vibration resistance and heat resistance, and cost, it is difficult for a configuration for controlling the PHY manager to use a processor having as high performance as a computer used in an office or home.

The present disclosure provides a vehicle relay device capable of reducing load for controlling the PHY manager and improving communication speed between a PHY manager and a PHY module.

An exemplary embodiment of the present disclosure provides a vehicle relay device. The vehicle relay device includes a plurality of physical (PHY) modules and one PHY manager. The plurality of PHY modules are configured to communicate in accordance with an Ethernet standard. The PHY manager is connected to the plurality of PHY modules, and configured to change an operation setting of each of the plurality of PHY modules and monitor an operation state of each of the plurality of PHY modules. The PHY manager is individually connected to each of the plurality of PHY modules by a Management Data Input/Output (MDIO) line as a signal line for transmitting and receiving management data for monitoring and controlling an operation of each of the plurality of PHY modules. The PHY manager includes a Management Data Clock (MDC) output unit configured to transmit an MDC that is a clock for performing transmission and reception of the management data with each of the plurality of PHY modules. When the PHY manager performs transmission and reception of the management data with at least one of the plurality of PHY modules as a communication target, the PHY manager (i) simultaneously transmits the management data to the MDIO line connected to the communication target and (ii) causes the MDIO line connected to a non-target module that is a PHY module with which the PHY manager does not perform transmission and reception of the management data to be in a high impedance state or stops transmitting the MDC to the non-target module.

In the exemplary embodiment of the present disclosure, the PHY manager of the vehicle relay device is individually connected to each of the plurality of PHY modules by the MDIO line. When the PHY manager exchanges the management data with a certain PHY module, the PHY manager causes the MDIO line connected to the PHY module not to be the communication target (that is, the non-target module) to be in the high impedance state or to stop the MDC. In the configuration, the non-target module is not notified that the PHY manager is to transmit or receive the management data. Thus, the configuration does not access the register of the non-target module. The high impedance state refers to a state in which the signal line (here, MDIO line) is electrically separated from the input/output terminal of the management data by using a switch or the like.

Further, since the management data is output to the plurality of PHY modules to be communicated at once, the contents of the registers of the plurality of PHY modules can be rewritten at once, and the predetermined register values can be read out at the same time. As a result, the average communication speed between the PHY module and the PHY manager can be increased.

In the configuration, one PHY manager collectively manages and controls the plurality of PHY modules. According to such a configuration, the load for controlling the PHY manager can be reduced, and the communication speed between the PHY manager and the PHY module can be improved.

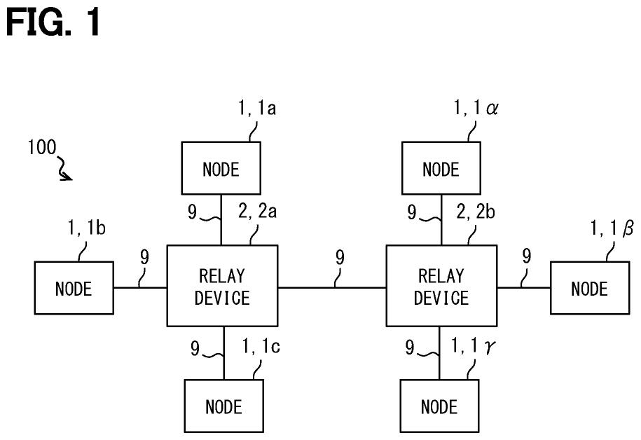

Hereinafter, embodiments of the present disclosure will be described with reference to the drawings. FIG. 1 is a diagram showing a configuration example of a vehicle communication system 100 according to the present disclosure. The vehicle communication system 100 is a communication system built in a vehicle. The vehicle communication system 100 according to the present embodiment is configured according to the vehicle Ethernet standard. “Ethernet” is a registered trademark. Hereinafter, data communication in accordance with the Ethernet communication protocol is referred to as Ethernet communication. Further, a communication frame refers to a communication frame in accordance with the Ethernet communication protocol (so-called Ethernet frame). The vehicle on which the vehicle communication system 100 is mounted is also referred to as a mounted vehicle.

The vehicle communication system 100 includes a plurality of nodes 1 and at least one relay device 2. The vehicle communication system 100 shown in FIG. 1 includes six nodes 1 and two relay devices 2 as an example. When distinguishing between the two relay devices 2, the two relay devices 2 are described as relay devices 2a and 2b. When distinguishing each of the six nodes 1, the six nodes 1 are described as the nodes 1a to 1c and 1α to 1γ. The node 1 corresponds to a communication device. The relay device 2 corresponds to a vehicle relay device.

Each of the nodes 1a to 1c is connected to the relay device 2a via a communication cable 9 so as to be able to communicate with each other. The nodes 1α to 1γ are connected to the relay device 2b via a communication cable 9 so as to be able to communicate with each other. The relay device 2a and the relay device 2b are also connected so as to be able to communicate with each other via the communication cable 9. The communication cable 9 may be a twisted pair cable.

The numbers of nodes 1 and relay devices 2 constituting the vehicle communication system 100 are an example, and can be changed as appropriate. Further, the network topology of the vehicle communication system 100 shown in FIG. 1 is an example and is not limited thereto. The network topology of the vehicle communication system 100 may be a mesh type, a star type, a bus type, a ring type, or the like. The network shape can also be changed as appropriate.

The node 1 is, for example, an Electronic Control Unit (ECU). The plurality of nodes 1 provide different functions. For example, the node 1a is an ECU that provides an autonomous driving function (so-called autonomous driving ECU). The node 1b is an ECU that acquires a program for updating a software of an ECU by wirelessly communicating with an external server and updates the software of the ECU to which the program is applied. The node 1c is an ECU that provides a smart entry function. The relay devices 2 can be connected with the ECU that provide various functions as the node 1.

Each node 1 performs transmission and reception of data with another node 1 via the relay device 2 according to the Ethernet communication protocol. Nodes connected to the relay device 2 may be nodes other than the node 1, such as a sensor. The node may be an external tool capable of dynamically changing the connection state to the vehicle communication system 100 by a user or an inspector. The relay device 2 can also correspond to a node from another point of view. For example, for the relay device 2a, the relay device 2b corresponds to one of the nodes connected to the relay device 2a. Unique identification information (MAC address) is designated to each of the nodes 1 and the relay devices 2.

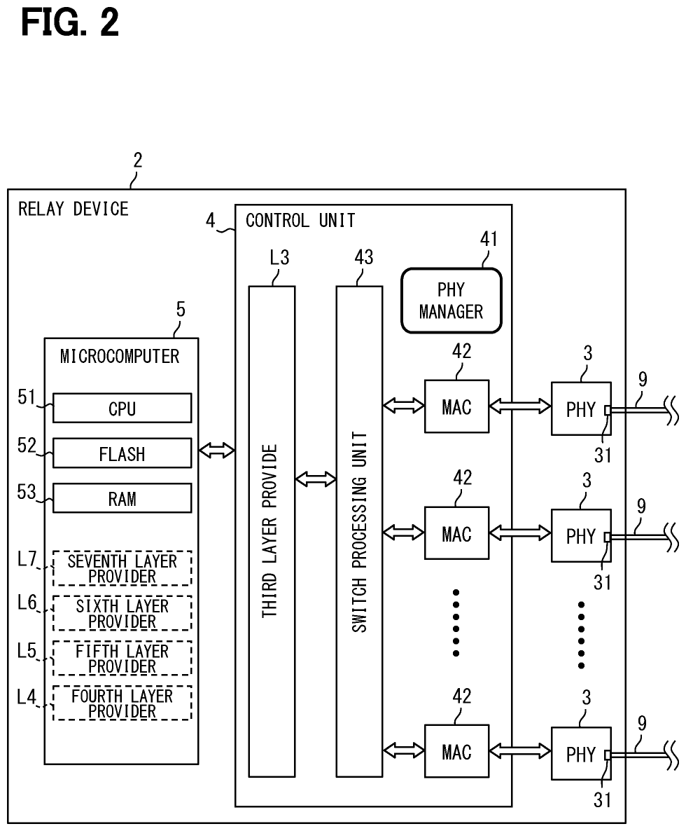

The relay device 2 is a device that transmits a communication frame received from a certain communication cable 9 to another communication cable 9 according to the destination of the communication frame. As shown in FIG. 2, the relay device 2 includes a plurality of physical layers 3 (PHYs3), a control unit 4, and a microcomputer 5.

The PHY 3 is connected to the communication cable 9 and functions as the physical layer in the OSI reference model. The PHY 3 includes a port 31 that is electrically connected to the communication cable 9. In the present embodiment, as an example, one communication cable 9 is connected to one PHY 3. That is, each PHY 3 includes one port 31 for connecting to the communication cable 9.

For example, one PHY 3 included in the relay device 2a is connected to the node 1a via the communication cable 9, and another PHY 3 included in the relay device 2a is connected to the node 1b via the communication cable 9. In addition, the relay device 2a includes a PHY 3 connected to the node 1c via a communication cable 9, a PHY 3 connected to the relay device 2b, and the like.

The number of PHYs 3 included in the relay device 2 corresponds to the number of nodes to which the relay device 2 can be connected. As an example, the relay device 2 of the present embodiment includes six PHYs 3 so as to enable Ethernet communication with a maximum of six nodes. As another configuration, the number of PHYs 3 included in the relay device 2 may be four or eight. Further, each of the PHYs 3 may include a plurality of ports 31. For example, the PHY 3 may have two ports 31. Each PHY 3 has the same configuration.

A PHY number and a PHY address are set in each of the plurality of PHYs 3. The PHY number is a number for the PHY manager 41 described later to identify a plurality of PHYs 3, and is set to a unique value for each PHY 3. The PHY address is an identifier for the microcomputer 5 to control the plurality of PHYs 3. In the present embodiment, since each PHY 3 is substantially managed by the PHY number, the PHY address may be a value that overlaps with other PHYs 3. Here, as an example, a common PHY address is set for each PHY 3.

For convenience, when the plurality of PHYs 3 included in the relay device 2 are distinguished, the port number K set in the PHY 3 is used for being described as the Kth PHY. For example, the first PHY 3 refers to the PHY 3 whose PHY number is set to 1, and the second PHY 3 refers to the PHY 3 whose PHY number is set to 2.

Generally, each PHY 3 converts the signal input from the connected communication cable 9 (hereinafter, the connection cable) into a digital signal that can be processed by the control unit 4, and outputs the digital signal to the control unit 4 (specifically, the MAC 42). Further, the PHY 3 converts the digital signal input from the control unit 4 into an analog signal, which is an electric signal and can be transmitted to the communication cable 9, and outputs the converted signal to a predetermined communication cable 9.

The PHY 3 is provided by an IC including an analog circuit. That is, the PHY 3 is a hardware circuit. Each of the PHYs 3 and the control unit 4 (specifically, MAC 42) are configured to communicate with each other according to the media independent interface (MII) standard. Communication between the PHY 3 and the MAC 42 is performed by reduced MII (RMII), reduced gigabit MII (RGMII), or the like. The PHY 3 is, for example, realized as a chipset including one port 31 and a register 32 for storing data such as an operation setting. The PHY 3 corresponds to a PHY module.

The PHY 3 operates according to the operation setting registered in the register 32. An item (in other words, parameter) that makes up the operation setting of the PHY 3 is, for example, communication standard applied to the PHY 3, a serial transmission method, communication speed, a role as a result of auto-negotiation (master or slave), an interrupt condition, an operation mode, or the like. The various parameters that define the operation of the PHY 3 are appropriately rewritten by the PHY manager 41 as will be described later. The communication standard applied to the PHY 3 is, for example, 100BASE-T1, 100BASE-TX, or 1000BASE-T1. The serial transmission method indicates whether to communicate by full-duplex communication or half-duplex communication. The interrupt condition indicates a condition for executing interrupt processing. The operation mode indicates whether to operate in the test mode.

Further, the register 32 includes a storage area that stores data indicating the operation state of the PHY 3, such as whether the PHY 3 is connected to another communication device (so-called a link partner) via the communication cable 9 to communicate with each other or whether the auto-negotiation is completed. For convenience, the data indicating the operation state of the PHY 3 is also referred to as operation state data.

The data (substantially values) of various items are stored in different addresses of the registers 32. The storage destinations of various items are preset according to the type. In other words, the data indicating whether the PHY 3 is connected to the link partner for communication corresponds to data indicating whether it is in a link-up state or a link-down state. The data for changing the operation setting and the operation state data correspond to management data described later.

In addition to the port 31 connected to the communication cable 9, the PHY 3 includes an MDC input terminal P21 and an MDIO terminal P22 as a configuration for communicating with the PHY manager 41 described later. Further, the PHY 3 includes, for example, a transmission clock output terminal, a transmission data input terminal, a reception clock output terminal, a reception data output terminal, a reset input terminal, and the like as terminals for performing transmission and reception of the data with the MAC 42. The transmission clock output terminal is a terminal for sequentially transmitting a transmission clock signal (so-called TX_CLK) of a predetermined frequency (for example, 25 MHz) to the MAC 42. The transmission data input terminal is a terminal into which data constituting a communication frame transmitted from the MAC 42 is input. The reception clock output terminal is a terminal for sequentially transmitting a reception clock signal (so-called RX_CLK) of a predetermined frequency (for example, 25 MHz) to the MAC 42. The reception data output terminal is a terminal for transmitting the data constituting the received communication frame to the MAC 42.

The control unit 4 is connected to each of the plurality of PHYs 3 and is also connected to the microcomputer 5 so as to be able to communicate with each other. The control unit 4 is programmed to execute functions of a second layer (data link layer) to a third layer (so-called network layer) in the OSI reference model. The control unit 4 includes one PHY manager 41, a plurality of MACs 42, a switch processor 43, and a third layer provider L3 as functional blocks.

The PHY manager 41 controls the operation of each PHY 3. The PHY manager 41 changes the operation setting of each PHY 3 and monitors the operation state. Details of the PHY manager 41 will be described later.

The MAC 42 performs medium access control in the Ethernet communication protocol. The MAC 42 is prepared for the respective one of the plurality of PHYs 3. The plurality of MACs 42 are connected to different one of the plurality of PHYs 3.

Each of the MACs 42 provides the switch processor 43 with a communication frame (hereinafter, also referred to as a reception frame) received from the PHY 3 connected to the MAC 42. In addition, each of the MACs 42 transmits the communication frame received from the switch processor 43 to the PHY 3 corresponding to the MAC 42, and transmits the communication frame to the communication cable 9. Each of the MACs 42 may be configured to provide the functions specified by IEEE 802.3. Each of the MACs 42 correspond to a MAC unit.

The switch processor 43 identifies the PHY 3 (strictly speaking, the port 31) to which the communication frame received from the MAC 42 is to be transmitted based on the destination MAC address included in the communication frame and an address table. The reception frame is relayed by transmitting the communication frame to the MAC 42 corresponding to the identified PHY 3. The address table is data indicating the MAC address of the node 1 connected to each PHY 3 (strictly speaking, each port 31). The MAC address for each PHY 3 is learned by various methods such as learning bridge and ARP (Address Resolution Protocol). A detailed description of the method of generating the address table will be omitted. The control unit 4 may be provided with the function of learning the MAC address of the connection destination for each PHY 3 (hereinafter, the address table update function), or the microcomputer 5 may be provided with the function.

The third layer provider L3 performs relay processing using an internet protocol (IP) address. In other words, the third layer provider L3 relays communication frames between different networks. The function of the third layer in the OSI reference model may be provided in the microcomputer 5. The functional arrangement in the relay device 2 can be changed as appropriate. For example, the control unit 4 may provide the function of the second layer, or may provide the functions of the fourth to seventh layers.

The control unit 4 is realized by using, for example, a field-programmable gate array (FPGA). The control unit 4 may be realized by using an application specific integrated circuit (ASIC). Further, the control unit 4 may be realized by using an MPU, a CPU, or a GPU. The control unit 4 having the above-described functions corresponds to a configuration that operates as a switch (in other words, a switching hub) or a router.

The microcomputer 5 is a computer including a CPU 51, a flash memory 52, a RAM 53, an I/O, and a bus line for connecting these components. The flash memory 52 stores a program (hereinafter, a relay device program) for causing a normal microcomputer to function as the microcomputer 5 of the present embodiment. The microcomputer 5 provides the functions as the fourth layer to the seventh layer in the OSI reference model by the CPU 51 executing the relay device program stored in the flash memory 52 while using the temporary storage function of the RAM 53.

That is, the microcomputer 5 includes a fourth layer provider L4, a fifth layer provider L5, a sixth layer provider L6, and a seventh layer provider L7 corresponding to each layer from the fourth layer to the seventh layer. The fourth layer provider L4 executes processing as the fourth layer (that is, a transport layer), and executes inter-program communication, data transfer guarantee, and the like. The fifth layer provider L5 executes processing as the fifth layer (that is, a session layer). The sixth layer provider L6 executes processing as the sixth layer (that is, a presentation layer). The seventh layer provider L7 executes processing as the seventh layer (that is, an application layer). Such a configuration corresponds to a configuration in which the fourth to seventh layers are realized by software processing. It should be noted that a storage medium for storing the program executed by the CPU is not limited to the flash memory 52. The program may be stored in a non-transitory tangible storage medium.

(PHY Manager 41)

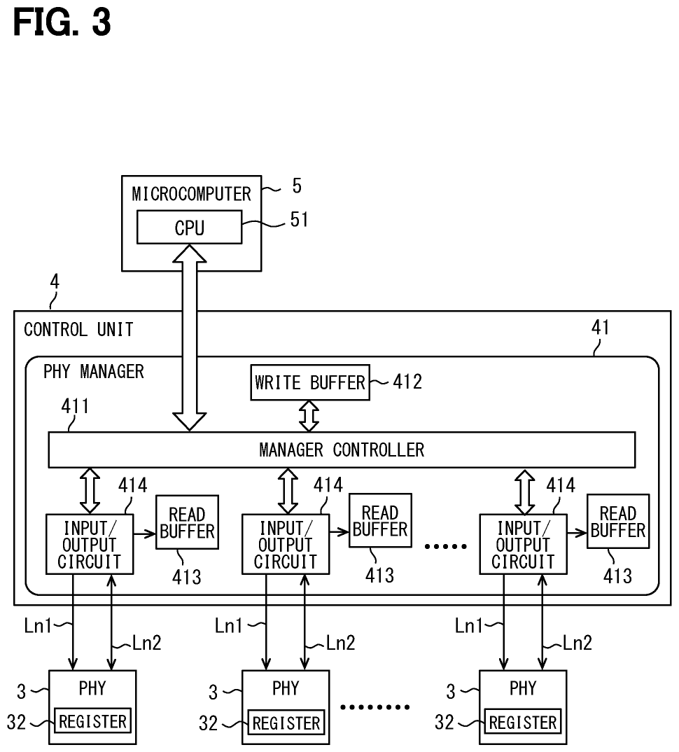

Next, the configuration and operation of the PHY manager 41 will be described with reference to FIG. 3. The PHY manager 41 of the present embodiment is connected to each of the plurality of PHYs 3 by an MDC line Ln1 and an MDIO line Ln2. MDC is an abbreviation for Management Data Clock, and MDIO is an abbreviation for Management Data Input/Output.

The MDC line Ln1 is a signal line through which the MDC, which is a clock signal for the PHY manager 41 to perform transmission and reception of the management data with the PHY 3, flows. The management data here refers to data for managing the PHY 3, and refers to the data indicating the above-mentioned operation setting and operation state. The MDIO line Ln2 is a signal line (in other words, a communication line) through which management data flows. Various signal lines correspond to buses.

The PHY manager 41 generally reads out the operation state data of each PHY 3 or changes the operation setting of the PHY 3 via the MDIO line Ln2. Transmission and reception of the management data via the MDIO line Ln2 is performed with reference to the clock edge of the MDC, which is a dedicated clock signal.

As shown in FIG. 3, the PHY manager 41 includes a manager controller 411, a write buffer 412, a read buffer 413, and a plurality of input/output circuits 414. The manager controller 411 controls the overall operation of the PHY manager 41. For example, the manager controller 411 collaborates with the input/output circuit 414 to write the operation setting data to the register 32 based on the instruction of the microcomputer 5. Further, the manager controller 411 reads out predetermined data from each register 32 in cooperation with each input/output circuit 414 based on the request from the microcomputer 5.

The write buffer 412 is a buffer for storing data to be written to the register 32 (hereinafter, write data). The write data includes data indicating the PHY 3 to which the data is to be written. The PHY 3 to be written is represented by the PHY number. The read buffer 413 is a buffer for storing the data read from PHY 3. The read buffer 413 is provided for each PHY 3. That is, the PHY manager 41 includes a read buffer 413 corresponding to each PHY 3.

The input/output circuit 414 controls signals flowing through the MDC line Ln1 and the MDIO line Ln2. The input/output circuit 414 is prepared for each PHY 3. For convenience, when the plurality of input/output circuits 414 included in the PHY manager 41 are distinguished, the PHY number K of the PHY 3 connected to the input/output circuit 414 is used for being described as the Kth input/output circuit 414. For example, the first input/output circuit 414 refers to the input/output circuit 414 connected to the PHY 3 whose PHY number is set to 1.

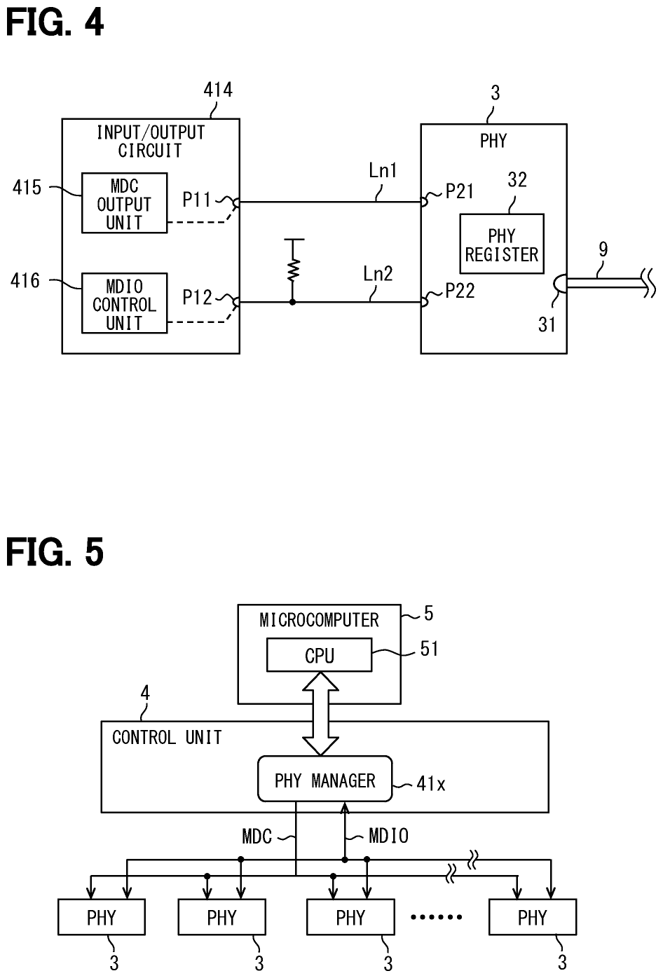

As shown in FIG. 4, each input/output circuit 414 includes an MDC output unit 415, an MDIO control unit 416, an MDC output terminal P11, and an MDIO terminal P12. The MDC output unit 415 transmits the MDC from the MDC output terminal P11 based on the instruction from the manager controller 411. The MDC output terminal P11 is a terminal for transmitting the MDC, and is connected to the MDC line Ln1. The other end of the MDC line Ln1 is connected to the MDC input terminal P21 of the PHY 3. The MDC input terminal P21 is a terminal for inputting the MDC.

The MDIO control unit 416 transmits predetermined write data and receives the data transmitted from the PHY 3 via the MDIO terminal P12 based on the instruction from the manager controller 411. The MDIO terminal P12 is a terminal for transmitting and receiving management data, and is connected to the MDIO line Ln2. The other end of the MDIO line Ln2 is connected to the MDIO terminal P22 of the PHY 3. The MDIO terminal P22 is a terminal for transmitting and receiving an electric signal corresponding to the management data, and is connected to the MDIO line Ln2. The MDIO line Ln2 is connected (that is, pulled-up), via a pull-up resistor, to a reference power supply line to which a predetermined reference potential is applied. The pull-up circuit for the MDIO line Ln2 may be provided inside the input/output circuit 414.

The MDIO line Ln2 can take three states: a high level state, a low level state, and a high impedance (Hi-Z) state. The high level state corresponds to a state in which a digital signal “1” is output from the MDIO terminal P12 or the MDIO terminal P22. The low level state corresponds to a state in which a digital signal “0” is output from the MDIO terminal P12 or the MDIO terminal P22.

The high impedance state is a state in which the MDIO terminal P12 is separated from the MDIO line Ln2 by using a switching element or the like. That is, the high impedance state is a state in which the circuit connected to the MDIO terminal P12 is open. In the high impedance state, no data is input to PHY 3. Hereinafter, for convenience, the output signal from the MDIO terminal P12 will also be referred to as an MDIO.

(Operation of PHY Manager 41)

Here, the operation of the manager controller 411 in a case of writing the data to the register 32 of the PHY 3 and a case of reading out the data stored in the register 32 of the PHY 3 will be described. In the following, the target PHY refers to the PHY 3 that is a target of access to the register 32 (in other words, the target of communication), such as writing data to the register 32 and reading out data from the register 32.

First, the operation of the manager controller 411 when data is written to the PHY 3 will be described. When the manager controller 411 writes predetermined data to any of the plurality of PHYs 3, the manager controller 411 causes the MDIO corresponding to the PHY3 (hereinafter, non-target PHY) that is not the target of writing the data to be in the high impedance state. The non-target PHY corresponds to a non-target module. The manager controller 411 transmits, to the input/output circuit 414 of the PHY 3 as a target (hereinafter, the target PHY), an instruction command (hereinafter, a write command) for causing the input/output circuit 414 to write the data to a predetermined address. As a result, a signal corresponding to the write command (write request signal described later) is simultaneously transmitted to one or a plurality of target PHYs.

The write command is data indicating data to be written and an address for the data to be written. The input/output circuit 414 to which the write command is input transmits a bit string (hereinafter, a write request signal) corresponding to the write command from the MDIO terminal P12. When writing data, the manager controller 411 causes the MDC output unit 415 of each input/output circuit 414 to transmit the MDC.

For example, when the same data is written to the same address of each register 32 for the first to third PHY 3, the manager controller 411 causes the input/output circuit 414 corresponding to each of the first to third PHY 3 to transmit the MDC and causes the MDIO terminal P12 to transmit the write request signal. Further, the manager controller 411 causes the input/output circuit 414 corresponding to each of the fourth to sixth PHYs 3, as the non-target PHY, to set the MDIO to be in the high impedance state. In the above example, each of the first to third PHYs 3 correspond to the target PHY.

The PHY 3 to which the bit string corresponding to the write command is input from the MDIO terminal P22 rewrites the value of the specified address (hereinafter, the address value) to the specified value according to the write command. Since the write request signal is simultaneously transmitted to each target PHY, the configuration can rewrite the operation settings of the plurality of PHYs 3 at once.

A case where the PHY manager 41 writes data to the register 32 of the PHY 3 corresponds to, for example, a case where the running power of the mounted vehicle is turned on and the relay device 2 is activated. As a startup process (in other words, a boot process), the relay device 2 writes various operation setting data to the register 32 of each PHY 3 so that the relay device 2 can communicate with each node 1. Further, when the roles such as master and slave are exchanged even after the start of the relay device 2 is completed, the value of the address corresponding to the item is appropriately rewritten in the register 32. In addition, when the PHY manager 41 diagnoses the relay device 2, the PHY manager 41 perform writing for setting the operation mode to the test mode.

Next, the operation of the manager controller 411 when reading out the data of the predetermined address of the register 32 included in the PHY 3 will be described. When the manager controller 411 reads out the value of a predetermined address from at least one of the plurality of PHYs 3, the manager controller 411 sets the MDIO of the input/output circuit 414 corresponding to the PHY 3 not to be accessed (that is, the non-target PHY) to be in the high impedance state. Further, to the input/output circuit 414 of the PHY 3 to be accessed (that is, the target PHY), the manager controller 411 simultaneously transmits a command (hereinafter, a read command) instructing to refer to the value of a predetermined address. The read command includes an address number for the read target. In addition, reading the value of a predetermined address corresponds to referring to the item and parameter corresponding to the address.

The input/output circuit 414 to which the read command is input transmits a bit string (hereinafter, a read request signal) corresponding to the read command from the MDIO terminal P12. When the input/output circuit 414 reads out the data, the manager controller 411 causes the MDC output unit 415 of each input/output circuit 414 to transmit the MDC until the data output by each target PHY is completed.

The reading out of the data stored in the register 32 of the PHY 3 by the PHY manager 41 is executed based on, for example, the instruction from the microcomputer 5. The parameter to be read is also instructed by the microcomputer 5. For example, the PHY manager 41 reads out the data indicating whether the auto-negotiation is in operation or completed from a predetermined PHY 3 based on the instruction from the microcomputer 5, and provides the data to the microcomputer 5.

Further, the PHY manager 41 may spontaneously read out the address value corresponding to the predetermined parameter in a predetermined monitor cycle and report the address value to the microcomputer 5. The monitor cycle may be appropriately designed, for example, 100 milliseconds. The types of parameters (in other words, items) to be periodically read out may also be appropriately designed. For example, the PHY manager 41 reads out the address value indicating the communication connection state (link up or link down) of each PHY 3 in each monitor cycle and transmits the value to the microcomputer 5.

### Effect of Embodiment

A first comparative configuration and a second comparative configuration are introduced. Here, taking a case where data of the same item is read from each of the first to third PHYs 3 as an example, the operation and effect of the configuration of the present embodiment (hereinafter, proposed configuration) will be described. In the following, the effect of the proposed configuration will be described by taking a case of reading the data of the register 32 as an example, but the same applies to a case of writing the data to the register 32.

As shown in FIG. 5, the first comparative configuration sequentially accesses the plurality of PHYs 3 using one PHY manager 41x. In the first comparative configuration, the bus for the MDC and the bus for the MDIO are shared by the plurality of PHYs 3. The PHY manager 41x of the first comparative configuration designates any one of the plurality of PHYs 3 as the access target using the PHY address and accesses the register 32 of the PHY 3 as the access target.

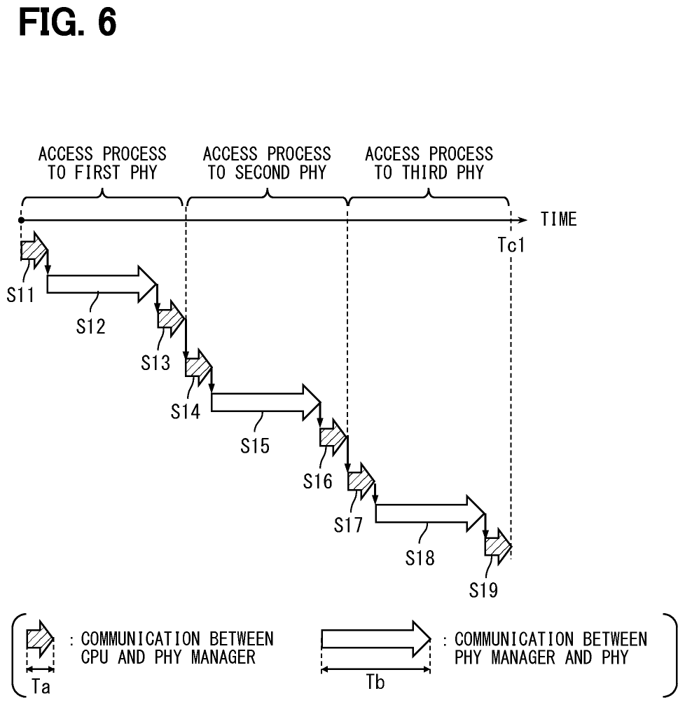

In the first comparative configuration, when the data of the same item is read from each of the first to third PHYs 3, as shown in FIG. 6, the registers 32 included in the first to third PHYs 3 are sequentially accessed in a predetermined order. That is, first, the CPU 51 instructs the PHY manager 41x to read the value of the designated address of the register 32 included in the first PHY 3 (S11). The PHY manager 41x reads out the value of the designated address of the register 32 included in the first PHY 3 based on the instruction of the CPU 51, and stores the value in the read buffer 413 of the PHY manager 41x (S12). The CPU 51 reads out the value stored in the read buffer 413 (S13), and completes the access processing for the first PHY 3.

Next, the CPU 51 instructs the PHY manager 41x to read the value of the designated address of the register 32 included in the second PHY 3 (S14). The PHY manager 41x reads out the value of the designated address of the register 32 included in the second PHY 3 based on the instruction of the CPU 51, and stores the value in the read buffer 413 of the PHY manager 41x (S15). The CPU 51 reads out the value stored in the read buffer 413 (S16), and completes the access processing for the second PHY 3.

When the access processing to the register 32 of the second PHY 3 is completed, the CPU 51 instructs the PHY manager 41x to read out the value of the designated address of the register 32 included in the third PHY 3 (S17). The PHY manager 41x reads out the value of the designated address of the register 32 included in the third PHY 3 based on the instruction of the CPU 51, and stores the value in the read buffer 413 of the PHY manager 41x (S18). The CPU 51 reads out the value stored in the read buffer 413 (S19), and completes the access processing for the third PHY 3.

As described above, in the first comparative configuration, the MDC and the MDIO are shared by the plurality of PHYs 3. Therefore, the access (writing/reading) to each PHY 3 by the PHY manager 41 must be performed at different time points (in other words, in order) for each PHY 3. Thus, even when the same processing is performed on the plurality of PHYs 3, the first comparative configuration takes time according to the number of PHYs 3 to be processed.

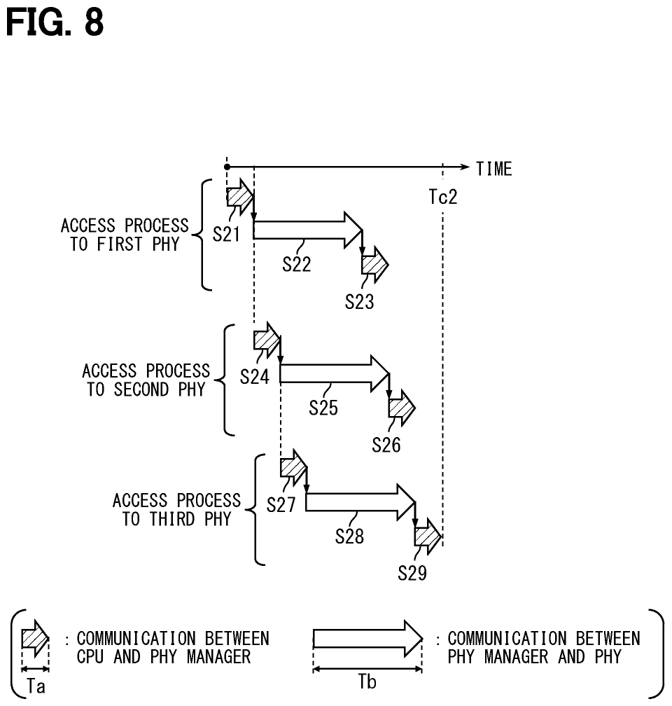

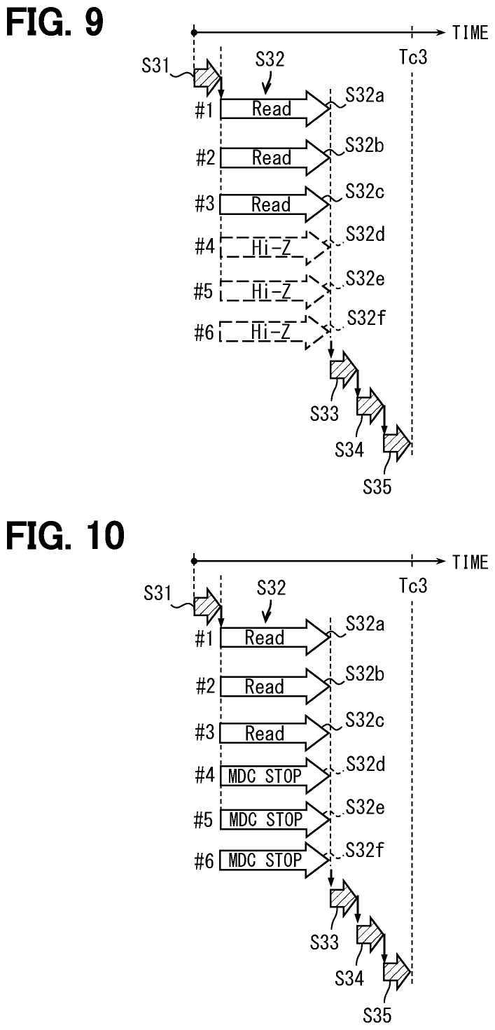

For example, it is assuming that the communication time between the CPU 51 and the PHY manager 41x is Ta and the communication time between the PHY manager 41x and the PHY 3 is Tb. In this case, the total time Tc1 required for the above processing is approximately 6×Ta+3×Tb. Ta may be about 5 microseconds and Tb may be about 25 microseconds. The hatched arrows in FIG. 6 conceptually represent the tasks executed by the CPU 51, and the white arrows conceptually represent the tasks executed by the PHY manager 41. The meanings of the arrows shown in FIGS. 8 and 9 are the same as those in FIG. 6.

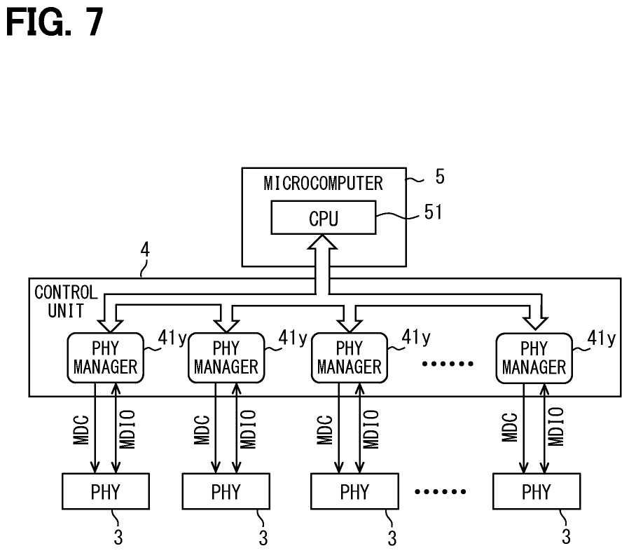

As shown in FIG. 7, the second comparative configuration controls each PHY 3 in parallel and independently using a plurality of PHY managers 41y corresponding to the plurality of PHYs 3. Each PHY manager 41y is connected to the PHY 3 to be controlled by an MDC line and an MDIO line. The operation of each PHY manager 41y is controlled by the CPU 51.

In the second comparative configuration, as in the first comparative configuration, when the same type of data is read from each of the first to third PHYs 3, as shown in FIG. 8, a plurality of PHY managers 41y corresponding to the first to third PHYs 3 operate in parallel. The following describes specific examples. First, the CPU 51 instructs the PHY manager 41y corresponding to the first PHY 3 to read the value of the designated address of the register 32 included in the first PHY 3 (S21). When the instruction to the PHY manager 41y corresponding to the first PHY 3 is completed, the CPU 51 instructs the PHY manager 41y corresponding to the second PHY 3 to read the value of the designated address of the register 32 included in the second PHY 3 (S24). Further, when the instruction to the PHY manager 41y corresponding to the second PHY 3 is completed, the CPU 51 instructs the PHY manager 41y corresponding to the third PHY 3 to read the value of the designated address of the register 32 included in the third PHY 3 (S27).

Based on the instruction from the CPU 51, each PHY manager 41y performs read processing of the value of the designated address in parallel, and stores the read value in each read buffer 413 (S22, S25, S28). The CPU 51 reads the value stored in each read buffer 413 and completes access to each PHY 3 (S23, S26, and S29).

According to such a second comparative configuration, the access time can be suppressed as compared with the first comparative configuration. For example, it is assuming that the communication time between the CPU 51 and the PHY manager 41y is Ta and the communication time between the PHY manager 41y and the PHY 3 is Tb. In this case, the total time Tc2 required for the above processing is approximately 4×Ta+1×Tb. However, since the CPU 51 needs to individually control the plurality of PHY managers 41y, there is a difficulty that the calculation load of the CPU 51 is relatively high.

In contrast to these first and second comparative configurations, the proposed configuration operates as shown in FIG. 9 when the same type of data is read from each of the first to third PHYs 3. That is, first, the CPU 51 instructs the PHY manager 41 to read the value of the designated address of the registers 32 included in the first to third PHYs 3 (S31). Here, each of the first to third PHYs 3 corresponds to the target PHY, and each of the fourth to sixth PHYs 3 corresponds to the non-target PHY. The PHY manager 41 sets the MDIO to each of the fourth to sixth PHYs 3 to be in the high impedance state based on the instruction of the CPU 51, and transmits a read request signal to the MDIO connected to each of the first to third PHYs 3 (S32).

Specifically, the manager controller 411 transmits the read request signal corresponding to an instruction from the CPU 51 to the first to third input/output circuits 414 respectively corresponding to the first to third PHYs 3 which are the target PHYs. At the same time or in advance, the manager controller 411 causes the input/output circuit 414 corresponding to each of the fourth to sixth PHYs 3, as the non-target PHY, to set the MDIO to be in the high impedance state. Each of the first to third input/output circuits 414 transmits the read request signal received from the manager controller 411 to the MDIO line Ln2, and receives the response data from the PHY 3 (S32a to S32c). The fourth to sixth input/output circuits 414 connected to the non-target PHY set the MDIO to be in the high impedance state based on the instruction from the manager controller 411 (S32d to S32f). As a result, the value of the designated address of the register 32 included in each of the first to third PHYs 3 is acquired and stored in the read buffer 413 corresponding to each PHY 3. Note that these processes are executed in parallel. The CPU 51 sequentially accesses the read buffers 413 for the first to third PHYs 3 and acquires the data (S33 to S35).

As described above, the manager controller 411 of the present embodiment corresponds to a configuration in which the instruction from the CPU 51 is distributed (in other words, multicast) to the input/output circuits 414 connected to the target PHY, according to another viewpoint. In FIG. 9, “#1” represents the operation of the first input/output circuit 414, and the arrow shown on the right side of “#4” represents the operation of the fourth input/output circuit 414. The arrows shown on the right side of “#2”, “#3”, “#5”, and “#6” in FIG. 9 are also represent the second, third, fifth, and sixth input/output circuits 414, respectively.

According to such a proposed configuration, as shown in FIG. 9, the access time can be suppressed as compared with the first comparative configuration. For example, it is assuming that the communication time between the CPU 51 and the PHY manager 41 is Ta and the access required time between the PHY manager 41 and the PHY 3 is Tb. In this case, the total time Tc3 required for the above processing is approximately 4×Ta+1×Tb. That is, access to the plurality of PHYs 3 can be realized in the similar time to the second comparative configuration.

In addition, according to the proposed configuration, the PHY manager 41 simultaneously transmits the read request signal corresponding to the instruction from the CPU 51 to the plurality of target PHYs. That is, the CPU 51 does not need to output instructions individually to the plurality of PHY managers 41. Therefore, the proposed configuration can suppress the arithmetic processing load of the CPU 51. Specifically, in the second comparative configuration, the number of times for the CPU 51 to output the read command to the PHY manager 41 is three times (S21, S24, S27). In the proposed configuration, the number of times for the CPU 51 to output the read command to the PHY manager 41 is once in S31.

Further, in the proposed configuration, it is not necessary for the control unit 4 to include a plurality of PHY managers 41 so as to correspond to each PHY 3. That is, the control unit 4 of the proposed configuration can be simplified as compared with the control unit of the second comparison configuration. As a result, it is expected that the cost of the control unit 4 can be reduced.

While the embodiments of the present disclosure have been described above, the present disclosure is not limited to the embodiments described above, and various modifications to be described below are included in the technical scope of the present disclosure, and may be implemented by various modifications within a scope not departing from the spirit described below. For example, various modifications to be described below can be implemented in combination as appropriate within a scope that does not cause technical inconsistency. Note that members having the same functions as those described in the above embodiment are denoted by the same reference numerals, and a description of the same members will be omitted. When only a part of the configuration is described, the configuration described in the above embodiment can be applied to the other part.

(First Modification)

In the above-described embodiment, the writing and reading of data to the register 32 of the non-target PHY is invalidated or prohibited by setting the MDIO to the non-target PHY to be in the high impedance state. In other words, the PHY 3 as the access target is limited by increasing the impedance of the MDIO. However, the method of invalidating/prohibiting access to the register 32 of the predetermined PHY3 is not limited thereto. The invalidation/prohibition (in other words, the limitation of the access target) of the access to the register 32 of the non-target PHY may be realized by stopping the MDC output to the non-target PHY as shown in FIG. 10. In other words, the PHY manager 41 may supply the MDC only to the target PHY.

(Second Modification)

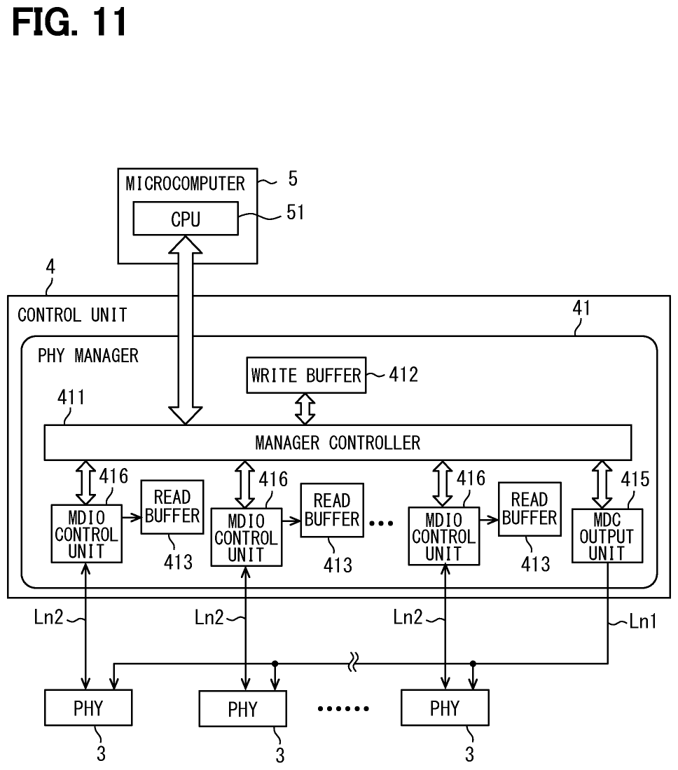

In the above-described embodiment, the MDC is individually input for each PHY 3. In other words, the MDC output unit 415 and the MDC line Ln1 are provided for each PHY 3. However the configuration is not limited thereto. As shown in FIG. 11, the MDC line Ln1 to each PHY3 may be shared. It should be noted that the technical idea disclosed in the first modification cannot be applied to the second modification. This is because since the MDC line Ln1 input to each PHY 3 is shared in the second modification, access to all PHYs 3 is impossible when the MDC output is stopped.

(Third Modification)

In the above, the PHY manager 41 includes the read buffer 413 for each PHY. The data read from each PHY3 may be stored in one buffer or register. The read data is stored in association with the PHY number indicating the read source. According to such a configuration, the CPU 51 can acquire data of a plurality of target PHYs by accessing one buffer or register. Thus, the configuration can further increase the speed.

The control unit 4 and the method therefor which have been described in the present disclosure may be also realized by a dedicated computer which constitutes a processor programmed to execute one or more functions concretized by computer programs. Also, the device and the method therefor which have been described in the present disclosure may be also realized by a special purpose hardware logic circuit. Also, the device and the method therefor which have been described in the present disclosure may be also realized by one or more dedicated computers which are constituted by combinations of a processor for executing computer programs and one or more hardware logic circuits. Further, the computer program may store a computer-readable non-transitional tangible recording medium as an instruction to be executed by the computer.

What is claimed is:

1. A vehicle relay device comprising:
a plurality of physical (PHY) modules configured to communicate in accordance with an Ethernet standard; and
one PHY manager connected to the plurality of PHY modules, and configured to change an operation setting of each of the plurality of PHY modules and monitor an operation state of each of the plurality of PHY modules, wherein
the PHY manager is individually connected to each of the plurality of PHY modules by a Management Data Input/Output (MDIO) line as a signal line for transmitting and receiving management data for monitoring and controlling an operation of each of the plurality of PHY modules,
the PHY manager includes a Management Data Clock (MDC) output unit configured to transmit an MDC that is a clock for performing transmission and reception of the management data with each of the plurality of PHY modules, and
when the PHY manager performs transmission and reception of the management data with at least one of the plurality of PHY modules as a communication target, the PHY manager (i) simultaneously transmits the management data to the MDIO line connected to the communication target and (ii) causes the MDIO line connected to a non-target module that is a PHY module with which the PHY manager does not perform transmission and reception of the management data to be in a high impedance state or stops transmitting the MDC to the non-target module.

2. The vehicle relay device according to claim 1, wherein
the PHY manager is individually connected to each of the plurality of PHY modules by an MDC line for transmitting and receiving the MDC, and
when the PHY manager performs transmission and reception of the management data with the at least one of the plurality of PHY modules, the MDC output unit stops transmitting the MDC to the MDC line connected to the non-target module.

3. The vehicle relay device according to claim 1, wherein
the PHY manager is configured to receive, as the management data, data that indicates a state of link in which the plurality of the PHY modules are connected.

4. The vehicle relay device according to claim 1, wherein
the PHY manager is configured to transmit, as the management data, data for rewriting the operation setting.

5. The vehicle relay device according to claim 3, wherein
the operation setting includes at least one of a communication standard for communicating with another communication device via a communication cable, a serial transmission method, and an interrupt condition.
